(19) United States
(12) Patent Application Publication
(10) Pub. No.: US 2017/0107679 A1
(43) Pub. Date: Apr. 20, 2017

(54) SNOW REMOVAL DEVICE

(71) Applicant: Andrew SCHELL, Norristown, PA (US)

(72) Inventor: Andrew SCHELL, Norristown, PA (US)

(21) Appl. No.: 14/883,078

(22) Filed: Oct. 14, 2015

(51) Int. Cl. E01H 5/10; B05B 7/14; E01H 10/00

(52) U.S. Cl. CPC E01H 5/106; E01H 10/007; B05B 7/1427

(57) ABSTRACT

A snow melting device that combines both a heating element and a compound for dissolving snow is provided. The snow melting device comprises a container including a snow melting compound, and a conduit with a first end connected to the container, and a second end connected to a distribution mechanism. The distribution mechanism includes a housing with an open first axial end and a second axial end connected to the conduit. A motor is positioned adjacent to the second axial end of the housing, drives a pump that is connected to the conduit and provides the snow melting compound to the distribution mechanism that includes a fan and a heating element. The fan atomizes the snow melting compound and sprays it out of the first axial end of the housing.

### FIELD OF INVENTION

This application is generally related to a snow removal device and more particularly related to an assembly including a snow melting solution and a heating element.

### BACKGROUND

Multiple methods and devices for snow removal exist. Know manual devices include shovels, which require significant physical exertion by the user. Other methods of snow removal include installing radiant heating elements below the ground. These systems are expensive and are not practical for many situations. Blow torch devices may be used to melt snow, however, these devices are dangerous due to the exposed flame and allow ice to refreeze quickly after the device has been used. It would be desirable to provide a snow removal device that both melted snow and prevented melted snow from freezing.

### SUMMARY

A snow melting device that combines both a heating element and a compound for dissolving snow is provided. In one embodiment, the compound is an organic compound. The snow melting device comprises a container including a snow melting compound, and a conduit with a first end connected to the container, and a second end connected to a distribution mechanism. The distribution mechanism includes a housing with an open first axial end and a second axial end connected to the conduit. A motor is positioned adjacent to the second axial end of the housing and drives a fan and a heating element.

Preferred arrangements with one or more features of the invention are described below and in the claims.

### BRIEF DESCRIPTION OF THE DRAWINGS

The foregoing Summary as well as the following Detailed Description will be best understood when read in conjunction with the appended drawings. In the drawings:

FIG. 1 shows a perspective view of the snow removal device.

FIG. 2 shows a partial cutaway view of the snow removal device.

FIG. 3 shows a heating element for the snow removal device.

FIG. 4 shows a partial cutaway view of a housing of the snow removal device.

FIG. 5 shows a partial cutaway view of a motor and fan of the snow removal device.

FIG. 6 shows a perspective view of an attachment for an end of the snow removal device.

FIG. 7 shows a cross-section view of a shaft of the snow removal device.

### DETAILED DESCRIPTION OF THE PREFERRED EMBODIMENTS

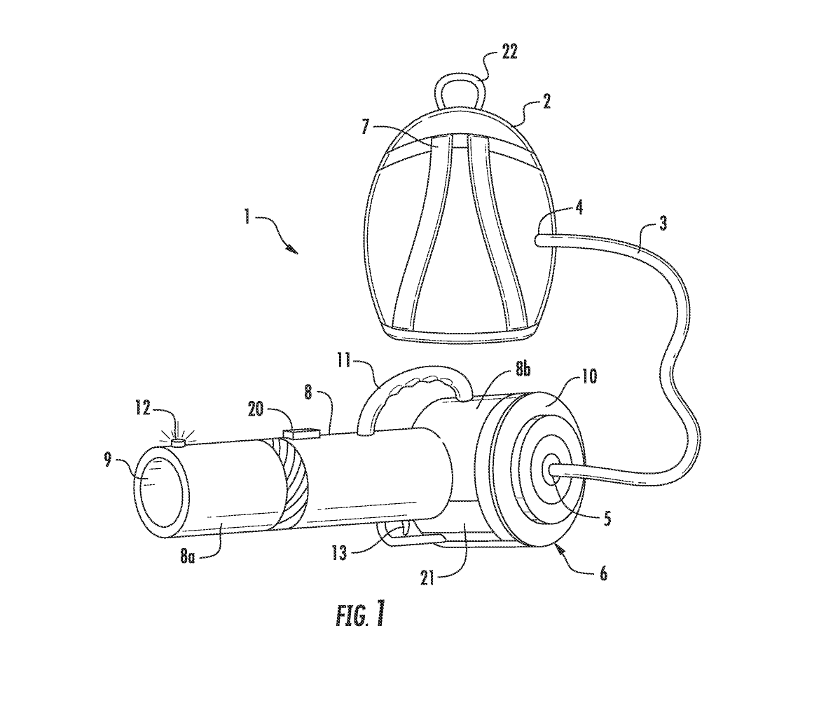

As shown in FIG. 1, the snow removal device 1 combines both a heating element and a compound for dissolving snow. The snow removal device 1 comprises a container 2 that holds a snow melting compound, and a hose 3 with a first end 4 connected to the container 2, and a second end 5 connected to a distribution mechanism 6. In a preferred embodiment, the snow melting compound is an organic compound. In one embodiment, the snow melting compound comprises a mixture of sodium and water. The compound is preferably selected from non-corrosive compounds to prevent damaging sidewalks, driveways, concrete, grass, automobiles, etc. The compound preferably also includes a bonding polymer that promotes adhesion to a ground surface or other surface to reduce snow accumulation on that surface. In another embodiment, the compound includes alfalfa, calcium, and water. In another preferred embodiment, the compound comprises magnesium chloride and calcium chloride. One of ordinary skill in the art recognizes that other solutions or mixtures of compounds, such as sodium chloride, could be used. The container 2 preferably includes shoulder straps 7 so the container 2 can be worn on a user's back. The container 2 may also be wheel mounted for transportation. In another embodiment, the container is mounted directly on a main body of the device 1.

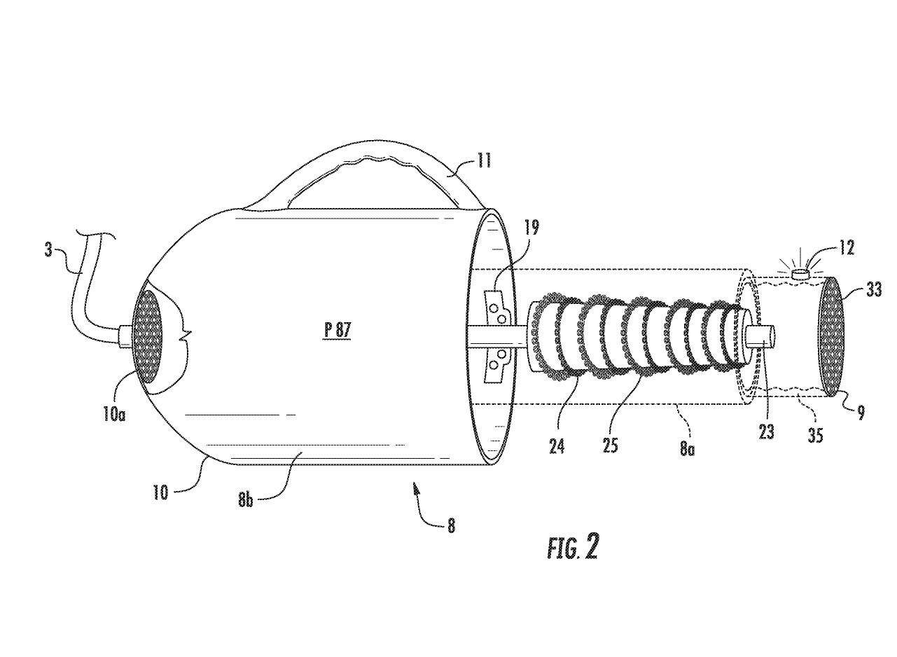

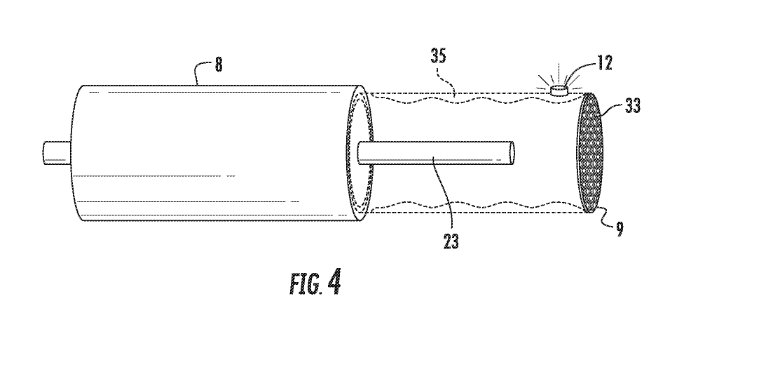

The distribution mechanism 6 includes a housing 8 with an open first axial end 9 and a second axial end 10 connected to the hose 3. The housing 8 is preferably comprised of a cylindrical tube having two outer diameters. A first section 8a of the housing 8 includes the exit portion for the solution, and a second section 8b of the housing includes a portion for connection with the hose 3. In one embodiment, the first section 8a of the housing 8 has a smaller outer diameter than the second section 8b of the housing 8. The housing 8 preferably includes at least one handle 11 and can include multiple handles or contoured portions. The housing 8 can also include a light 12, preferably near the open first axial end 9. The housing 8 preferably includes a switch or trigger 13 for actuating components within the distribution mechanism 6 and controlling the flow of the solution from the container to the distribution mechanism 6. The housing 8 preferably includes an outer layer of aluminum, and an insulation layer of mica. The housing 8 can include additional layers of insulation. In one embodiment, the housing 8 includes an inner layer of Fiberfrax® and an outer layer of leather for insulation. As shown in FIGS. 2 and 4, the inside of the housing 8 at the second end 10 of the housing 8 can include an absorbent material 35 to collect any excess mixture. In one embodiment the housing 8 includes an inner housing comprising a nickel chromium cylindrical tube.

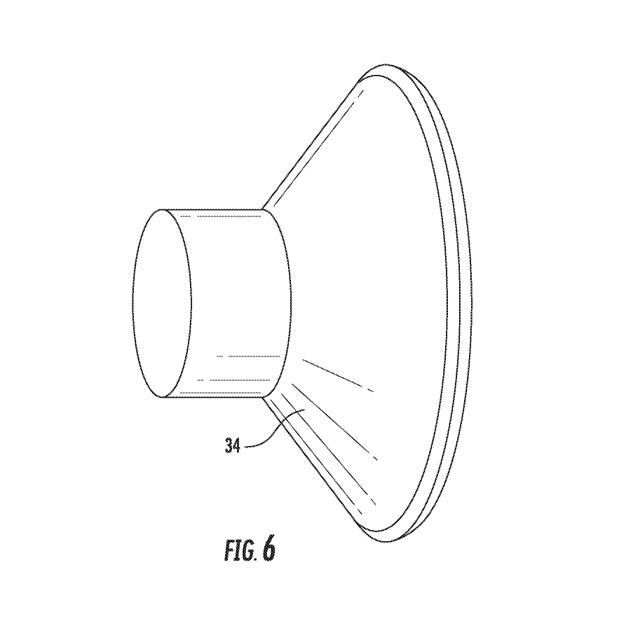

As shown in FIGS. 2-5, a hollow shaft 23 extends through the housing 8. The hose 3 extends into the housing 8 through the hollow shaft 23. As shown in FIG. 4, the hollow shaft 23 terminates before the first end 9 of the housing 8. The second axial end 10 of the housing can include a plurality of ventilation holes 10a for drawing air into the housing 8. The first axial end 9 of the housing 8 is open for directing the solution out of the housing 8 and can include a mesh wiring 33. In one embodiment, the first axial end 9 of the housing 8 includes an attachment 34, shown in FIG. 6, with a narrow rectangular opening for blowing a flat layer of hot air and solution out of the housing 8.

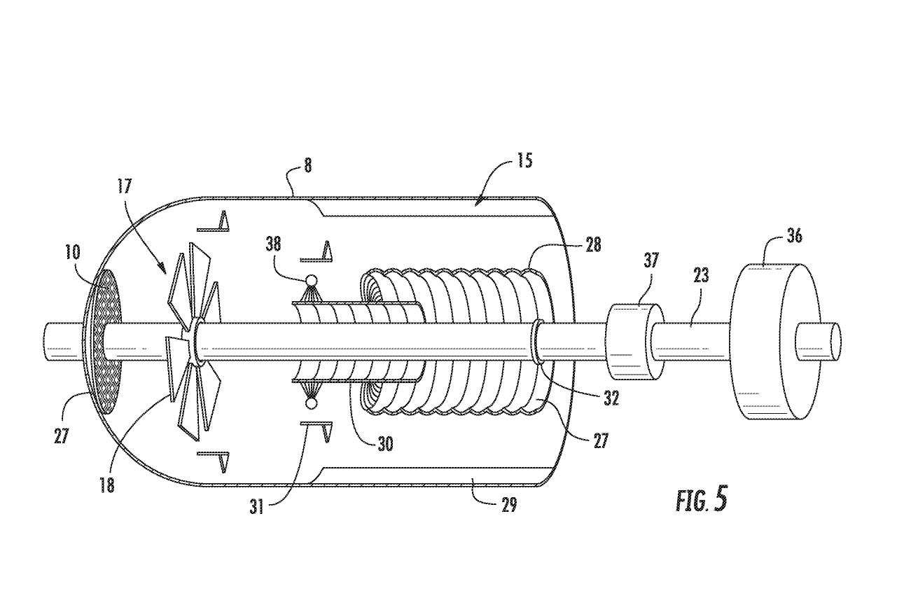

As shown in FIG. 5, a motor 15 is arranged circumferentially about the hollow shaft 23 which houses the hose 3. The motor 15 is positioned adjacent to the second axial end 10 of the housing 8 near where the hose 3 enters to the housing 8. A fan 17 or air mover with blades 18 is also arranged in the housing 8 along with a heating element 19. The motor 15 includes electrical pins 31 and a commutator 30. The electrical pins transfer electricity to the commutator 30. The commutator 30 transfers electricity to a copper winding 28. The motor 15 includes an armature 27 and the copper winding 28. Bearings 32 are provided around the shaft 23 for supporting the rotating armature 27. In on embodiment, there are two bearings 32, one on either end of the shaft 23. Brushes 38 can also be provided in the motor 15 for transferring current from stationary coils to moving parts of the motor 15. In a preferred embodiment, the brushes 38 are on opposite sides of the commutator 30. The magnets 29 are arranged opposite to one another and are supplied with an electrical current to alternate magnetic fields and cause the copper winding 28 and shaft 23 to spin. The shaft 23 is fixed with the blades 18 of the fan 17, which also spin as a result of the copper winding 28 and armature 27 rotating.

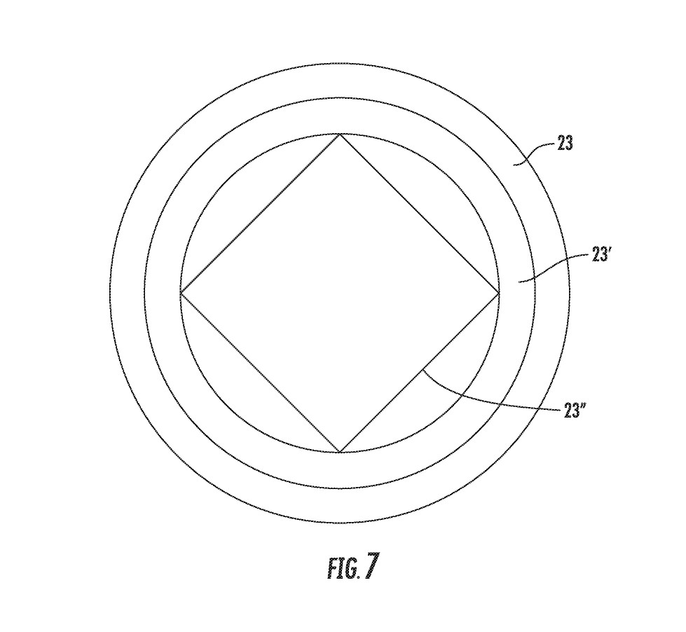

A cross-sectional area of the shaft 23 is shown in FIG. 7. In one preferred embodiment, the rotating shaft 23 encloses an inner shaft member 23′ which is stationary. A bearing can be arranged between the rotating shaft 23 and the inner shaft member 23′. A solution conduit 23″ is arranged within the inner shaft member 23′ for directing solution through the housing 8. The solution conduit 23″ is preferably formed from metal, and defines an inner channel through which solution can flow. Insulation can be provided in the space between the solution conduit 23″ and the inner shaft member 23′. A layer of mica sheet and nichrome wire can be provided around the solution conduit 23″ to heat the solution. The nichrome wire and the mica sheet preferably terminate directly at the end of the shaft 23.

One end of the solution conduit 23″ is connected to the hose 3 from the container 2. The solution conduit 23″ is held in place in the housing 8 via a nut and bolt combination or other fixing means. The other end of the solution conduit 23″ expels the solution form the housing 8 via an adjustable spray diffuser or other spraying apparatus.

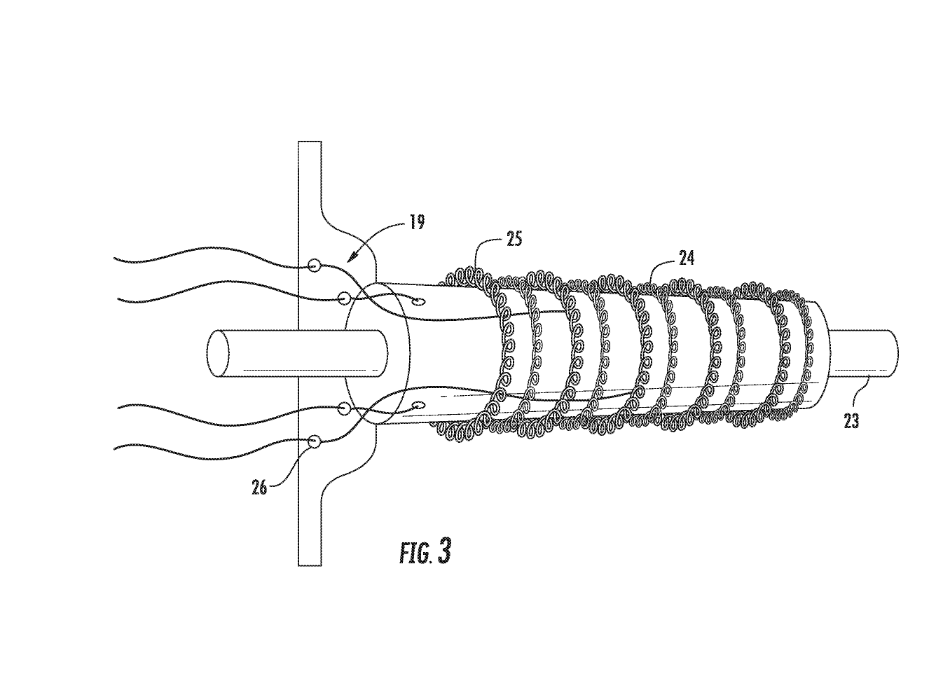

The heating element 19 can include any suitable heating configuration, such as a resistor and coil. The heating element 19 heats the air being drawn into the housing 8 by the fan 17. In another embodiment, a heating element 19 is provided between the hose 3 and fan 17 so that the snow melting compound is heated when traveling from the container 2 to the distribution mechanism 6. As shown in FIG. 3, the heating element 19 of a preferred configuration includes contacts 26 to distribute electricity. In one embodiment, the contacts 26 are formed from copper. The heating element 19 also includes a metal wire 25, preferably formed from nichrome which heats up air being drawn into the housing 8 by the fan 17. The metal wire 25 is distributed through a thick mica sheet arranged in the housing 8. Diodes 24 can also be provided in the heating element 19 for distributing electricity. The diodes 24 ensure current flows in one direction and convert AC power to DC power. The diodes 24 prevent the device from short-circuiting. The contracts 26 distribute electricity throughout the nichrome wire 25, which is heated via electricity.

In one preferred embodiment, the fan 17 simultaneously atomizes and heats the snow melting compound. The housing 8 can include a mist diffuser that turns a stream of liquid into a fine mist or spray. The fan 17 expels a spray of the snow melting compound through the housing 8 and out of the first axial end 9 of the housing 8. A user can control the amount of snow melting compound being expelled from the housing by varying the pressure applied to the trigger 13. In another embodiment, the distribution mechanism 6 can include a compressor 36 and a pump 37, shown in FIG. 5, and the compressor 36 creates a pressurized steam mixture of the snow melting compound. The housing 8 can include a control panel 20 connected to a circuit board that controls the components of the distribution mechanism 6. The control panel 20 can control the heating element 19, the motor 15, the pump 37, the fan 17, the light 12, and any other component on the device 1. In one embodiment, the first axial end 9 of the housing 8 can include a salt distribution component for a secondary way to melt and dissolve snow.

The components of the distribution mechanism 6 are powered by a rechargeable battery 21 or an external power source such as a gas engine. In another embodiment, the device 1 is powered via electric power, and includes a rechargeable battery. In another embodiment, the device 1 is powered via electric power and is plugged in to a power outlet. In one embodiment, the container 2 includes a manual hand pump 22 that builds up pressure in the container 2 in the same manner as a garden sprayer. A gasket can be provided between the hand pump 22 and the container 2. The hand pump 22 provides enough pressure to expel the snow melting solution through the distribution mechanism 6.

The present embodiments are therefore to be considered in all respects as illustrative and not restrictive, the scope of the invention being indicated by the appended claims rather than by the foregoing description, and all changes which come within the meaning and range of equivalency of the claims are therefore to be embraced therein.

What is claimed is:

1. A snow removal device comprising:
a container that holds a snow melting compound,
a conduit that is connected between the container and a distribution mechanism,
the distribution mechanism comprising:
a housing with first and second axial ends with one of the axial ends connected to the conduit,
a pump that is connected to the conduit and draws the snow melting compound into the distribution mechanism; and
an air mover that distributes the snow melting compound out of the other axial end.

2. The snow removal device of claim 1 further comprising a heater positioned between the pump and the other axial end.

3. The snow removal device of claim 1, wherein the housing includes a light.

4. The snow removal device of claim 1, wherein the housing includes a handle.

5. The snow removal device of claim 1, wherein the container includes a hand pump for drawing the snow melting compound from the container to the distribution mechanism.

6. The snow removal device of claim 1, wherein the distribution mechanism includes a power source.

7. The snow removal device of claim 6, wherein the power source is a battery.

8. The snow removal device of claim 6, wherein the power source is an AC electrical connection.

9. The snow removal device of claim 1, wherein the distribution mechanism includes a compressor connected to the pump, and the compressor creates a steam mixture of the snow melting compound.

10. The snow removal device of claim 1, wherein the snow melting compound is an organic compound.

11. The snow removal device of claim 1, wherein the snow melting compound is comprised of alfalfa, calcium, and water.

12. The snow removal device of claim 1, further comprising an inner housing located within the housing, the inner housing comprising a nickel chromium cylindrical tube.

13. The snow removal device of claim 1, wherein the container includes shoulder straps.

14. The snow removal device of claim 1, wherein the housing is covered in a thermal insulating material.

15. A snow removal device comprising:
a container that holds a snow melting compound,
a conduit connected between the container and a distribution mechanism,
the distribution mechanism comprising:
a housing with first and second axial ends, the first axial end includes an opening to spray the snow melting compound out of the housing, and the second axial end is connected to the conduit and includes ventilation holes for drawing air into the housing,
a motor that drives a fan for drawing air into the ventilation holes on the second axial end of the housing, and
a heating element that heats air drawn into the housing.
